(19) United States
(12) Patent Application Publication
(10) Pub. No.: US 2019/0227404 A1
(43) Pub. Date: Jul. 25, 2019

(54) Terahertz Radiation Emitters

(71) Applicant: NATIONAL UNIVERSITY OF SINGAPORE, Singapore (SG)

(72) Inventors: Yang WU, Singapore (SG); Hyunsoo YANG, Singapore (SG)

(73) Assignee: National University of Singapore, Singapore (SG)

(21) Appl. No.: 16/318,530

(22) PCT Filed: Jul. 19, 2017
(86) PCT No.: PCT/SG2017/050360

§ 371 Date: Jan. 17, 2019

(30) Foreign Application Priority Data
Jul. 20, 2016 (SG) 10201605969S

(51) Int. Cl. G02F 2/02; H01F 10/32; G01N 21/3586

(52) U.S. Cl. CPC G02F 2/02; H01F 10/329; G02F 2203/13; H01F 10/325; G01N 21/3586; H01F 10/3286

(57) ABSTRACT

A method of generating electromagnetic radiation in the terahertz frequency range is disclosed herein. In one embodiment, the method comprises the steps of providing a bi-layer heterojunction comprising a ferromagnetic metal layer adjacent a non-magnetic metal layer, wherein the non-magnetic layer comprises one of platinum or tungsten and applying a femtosecond laser beam to the heterojunction. The terahertz electromagnetic radiation may be generated by an inverse spin orbit interaction comprising an inverse spin Hall effect and/or inverse spin orbital torques. A terahertz emitter device and an apparatus for generating electromagnetic radiation in the terahertz frequency range are also described.

### TECHNICAL FIELD

The present invention relates to a method of generating electromagnetic radiation in the terahertz frequency range. In particular, although not exclusively, the invention relates to a method which utilises an inverse spin orbit interaction (SOI). A terahertz radiation emitter and apparatus are also described.

### BACKGROUND

Terahertz radiation consists of electromagnetic waves which lie between the optical and the microwave spectrum, within the frequency band of 0.1 to 10 terahertz (THz).

Terahertz spectroscopy uses short pulses of terahertz radiation to investigate the properties of a material. It is a powerful characterization method due to its unique applications. As the bonding energy of many large molecules is in the range of the photon energy of the THz electromagnetic waves (ranging from 0.5 to 50 meV), THz spectroscopy can be used in material composition analysis for biological, medical, and chemical research. Within the THz frequency range, the photon-matter interaction in solid state physics follows the Drude model, which explains the transport properties of electrons in materials, especially metals. The THz wave propagation properties highly depend on the conductivity of materials, which results in many materials such as clothing, paper, masonry, plastic, ceramics, dry woods and semiconductor wafers being transparent to THz waves. Furthermore, THz spectroscopy is also utilized as a non-destructive/non-invasive method for conductivity measurements of a wide range of materials. Terahertz emission spectroscopy is also used in the developing field of spintronics, as discussed by T. J. Huisman et al in Nature Nanotech 11, 455-458, 2016, and by T. Kampfrath et al in Nature Nanotech 8, 256-260, 2013.

THz time domain spectroscopy (THz TDS) comprises interaction of the electric field of a THz pulse in a detector with a short laser pulse (e.g. 0.1 picoseconds). This produces an electrical signal which is proportional to the electric field of the THz pulse at the time the laser pulse gates the detector on. This process is repeated and the timing of the gating laser pulse is varied. Hence, the electric field of the THz pulse can be reconstructed as a function of time. A Fourier transform is performed to obtain the frequency spectrum from the time-domain data.

As a result of the many useful applications for THz technologies, there is a great interest in developing high performance THz sources. However, THz waves cannot be efficiently generated by conventional optical or microwave sources. Current moderately sized THz sources typically only generate a few milliwatts and are therefore expensive and also difficult to detect.

For THz TDS, optical rectification from electro-optical (EO) crystals, transient electrical current in semiconductor antennas, and air plasmas induced by a focused femtosecond (fs) laser beam are the main streams for THz wave generation. Recently, there have been a few reports showing the potentials of nonmagnetic (NM) and ferromagnetic (FM) metal film junctions (heterojunctions) as THz sources. However, these have not been proven as practically useful THz emitters, due to the low emission intensities.

There is therefore a need to provide a more effective source of THz radiation, particularly for use in THz TDS.

### SUMMARY

According to a first aspect of the present invention, there is provided a method of generating electromagnetic radiation in the terahertz frequency range. The method comprises the steps of providing a bi-layer heterojunction comprising a ferromagnetic metal layer adjacent a non-magnetic metal layer and applying a femtosecond laser beam to the heterojunction. The non-magnetic layer comprises one of platinum or tungsten.

In one embodiment, the ferromagnetic metal layer may have a thickness of substantially between 1 nanometre and 8 nanometres.

The non-magnetic metal layer may have a thickness of substantially between 2 nanometres and 10 nanometres. The non-magnetic metal layer may have a thickness of substantially between 5 nanometres and 7 nanometres.

Preferably, the metal layers may be provided on a substrate layer, such that the non-magnetic metal layer is adjacent the substrate layer. The substrate layer may comprise one of glass, quartz, sapphire, polyethylene terephthalate and silicon. The substrate layer may have a thickness of between substantially 0.0001 mm to 10 mm.

It is envisaged that a capping layer may be provided on the metal layers. The capping layer may be adjacent to the ferromagnetic metal layer and may comprise one of Al2O3 or SiO2.

It is also possible that a magnetic underlayer may be provided adjacent the ferromagnetic metal layer or the non-magnetic metal layer. The underlayer may be antiferromagnetic.

In one embodiment, the femtosecond laser beam may be applied such that the laser beam is incident upon the capping layer. Alternatively, the femtosecond laser beam may be applied such that the laser beam is incident upon the substrate.

The laser beam may be applied in a pulse of substantially between 1 femtosecond to 1 picosecond and at a wavelength of substantially 200 nanometres to 2 micrometres. Preferably, the laser beam may be applied with an energy density of at least 0.1 nJ/cm2. Specifically, the laser beam may be applied using a compact fibre laser.

Advantageously, an external magnetic field may be applied to the heterojunction along an axis perpendicular to a direction of application of the laser beam. The external magnetic field may be applied at substantially 1000 oersted.

An electric current of substantially between −500 milliamperes and 500 milliamperes may be applied to the heterojunction.

The terahertz electromagnetic radiation may be generated by an inverse spin orbit interaction comprising an inverse spin Hall Effect. The terahertz electromagnetic radiation may be generated by an inverse spin orbit interaction comprising inverse spin orbital torques.

It is envisaged that emitted terahertz electromagnetic radiation may be independent of the polarisation of the incident laser beam. Further, it is also envisaged that emitted terahertz electromagnetic radiation intensity may be independent of the degree of curvature of the terahertz emitter device.

Advantageously, the heterojunction may be annealed at temperatures of up to 450° C., preferably 150° C., prior to application of the laser beam.

The ferromagnetic metal layer may comprise cobalt. The ferromagnetic metal layer may comprise iron or nickel.

According to a second aspect of the invention, there is provided a terahertz radiation emitter device. The device comprises a bi-layer heterojunction comprising a ferromagnetic metal layer adjacent a non-magnetic metal layer, a substrate layer and a capping layer. The non-magnetic layer comprises one of platinum or tungsten.

According to a third aspect of the present invention, there is provided an apparatus for generating electromagnetic radiation in the terahertz frequency range. The apparatus comprises the terahertz radiation emitter of the second aspect above and a femtosecond laser configured to apply a laser beam to the heterojunction.

According to a fourth aspect, there is provided a method of detecting the presence of explosive substances and/or drugs-of-abuse. The method comprises generating electromagnetic radiation in the terahertz frequency range according to the method of the first aspect above, and testing for the presence or absence of absorption peaks at predetermined frequencies.

It should be appreciated that features relevant to one aspect may also be relevant to the other aspects.

### BRIEF DESCRIPTION OF THE DRAWINGS

FIG. 1a is a schematic of a nonmagnetic/ferromagnetic (NM/FM) THz emitter device;

FIG. 1b is a graphical representation of spin density induced by a laser pulse with respect to time in a NM/FM heterostructure;

FIG. 1c is a graphical representation of a THz TDS signal emitted from an emitter device with respect to time;

FIG. 1d is a graphical representation of example data of a THz TDS signal acquired using a compact fibre laser;

FIGS. 2a to 2i are graphical representations of THz TDS signals emitted by devices having different NM layers;

FIG. 3a is a graphical representation of calculated current density in the time domain, with an inset portion illustrating the electric field of the THz signal;

FIG. 3b is a graphical representation of THz TDS signals from a group of samples having a thin copper layer inserted between the NM and FM layers;

FIG. 4a is a graphical representation of the peak signal of the THz TDS emissions from devices having different NM layer thicknesses;

FIG. 4b is a graphical representation of the peak signal of the THz TDS emissions from devices having different FM layer thicknesses;

FIG. 4c is a graphical representation of calculated spin accumulations with NM layers of different thicknesses;

FIG. 4d is a graphical representation of calculated spin accumulations with FM layers of different thicknesses;

FIG. 5a is a graphical representation of THz TDS signals from a standard <110> cut ZnTe crystal and a device having an Al2O3 capping layer;

FIG. 5b is a graphical representation of frequency domain spectra for the THz TDS signals illustrated in FIG. 5a;

FIG. 5c is a graphical representation of peak THz TDS signals with different laser source beam polarizations and different external magnetic field directions (rotating in the film plane);

FIG. 5d is a graphical representation of a THz TDS signal acquired from a device at four different bending curvatures;

FIG. 5e is a representation of the bent device of FIG. 5d;

FIG. 6a is a graphical representation of THz TDS signals with devices having Si substrates;

FIG. 6b is a graphical representation of THz TDS signals with devices having quartz substrates;

FIG. 7 is is a graphical representation of THz TDS signals with devices having different incident light circular polarizations;

FIG. 8 illustrates a device at four different bending curvatures;

FIG. 9a is a graphical representation of incident laser power dependence of THz TDS signals, using a 1 kHz repetition rate laser, with an inset portion illustrating an enlarged view of one of the ranges;

FIG. 9b is a graphical representation of a THz TDS signal acquired with incident laser power of 0.15 mW and laser repetition rate of 1 kHz;

FIG. 10 is a graphical representation of laser pulse duration dependence of THz TDS signals, using a 1 kHz repetition rate laser;

FIG. 11 is a graphical representation of THz TDS signals from a set of sample devices annealed under different temperature conditions;

FIG. 12 is a graphical representation of a THz TDS signal from a device to which an electric current is applied; and

FIG. 13 illustrates a method of generating THz emissions.

### DETAILED DESCRIPTION

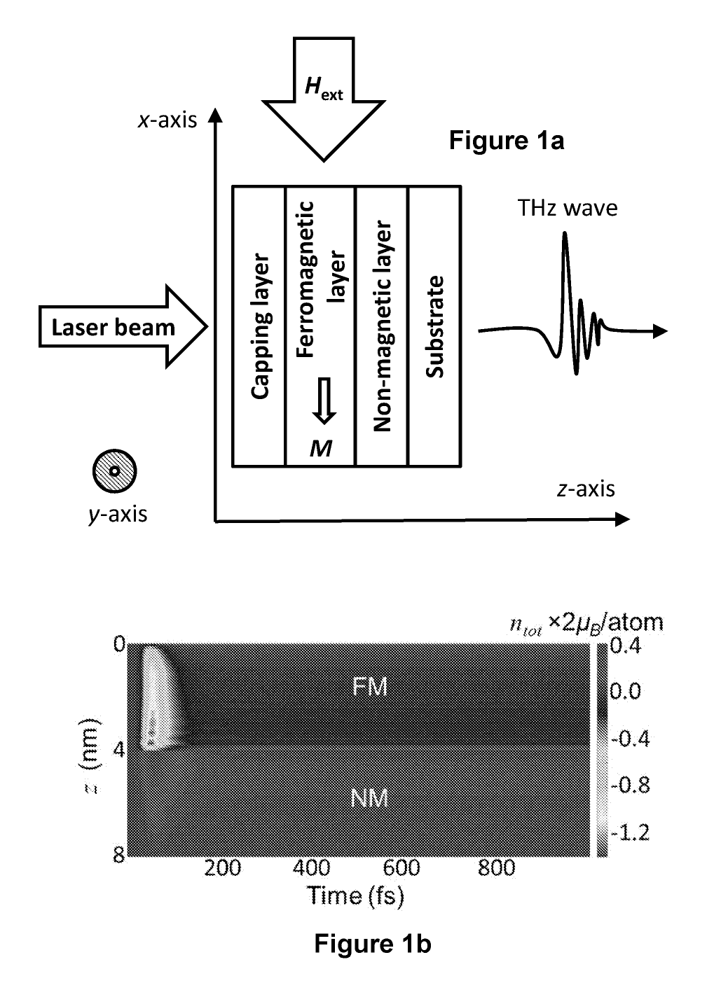

A method of and an apparatus for generating terahertz (THz) electromagnetic radiation will now be described with reference to FIGS. 1 to 13, together with a THz emitter device and apparatus. The generated THz radiation can be used in THz TDS spectroscopy and in other THz applications.

A schematic illustration of an exemplar nonmagnetic/ferromagnetic (NM/FM) THz emitter device is illustrated in FIG. 1a. The device has an optimised heterostructure comprising a substrate layer adjacent a non-magnetic (NM) layer, a ferromagnetic (FM) layer adjacent the NM layer, and a capping layer adjacent the NM layer. In this illustrated example, the FM layer comprises cobalt (Co); alternative FM materials may comprise iron (Fe) or nickel (Ni) and/or their combinations, with and without other metals. For example, the FM layer may comprise CoFeB. Other magnetic materials including ferrimagnets and antiferromagnets may be used as the FM layer.

The FM/NM layers form a bi-layer heterostructure comprising a heterojunction. In other words, in this illustrated example, the device structure comprises a stack of thin layers or films deposited upon a substrate layer, in the following order: substrate, NM layer, FM layer, capping layer. The device is typically less than around 16 nanometres (nm) thick, including the substrate and capping layers.

In other embodiments, not shown here, the device structure may comprise a stack of thin layers or films deposited upon a substrate layer, in the following order: substrate, FM layer, NM layer, capping layer. In still further embodiments, the device structure may also comprise an underlayer, which may be provided upon the substrate prior to deposition of the NM/FM layers, and the device structure may have the following order: substrate, underlayer, FM layer, NM layer, capping layer, or substrate, underlayer, NM layer, FM layer, capping layer. The underlayer may be adjacent the FM layer and may comprise a thin layer of magnetic material, such as Cu, Ta, TaN, Ti, IrMn, PtMn, Cr or Ru. The underlayer may prevent oxidation of the NM or FM layer by the substrate and/or may define the magnetisation direction of the FM layer, thereby eliminating the requirement for an external magnetic field to be applied. An underlayer as described above may also be used as an adhesion layer and/or to orient the crystalline texture of the FM/NM layers.

An apparatus for generating electromagnetic radiation in the terahertz frequency range comprises the emitter device as described with reference to FIG. 1a. The apparatus further comprises a femtosecond laser, which in this example is configured to emit a 800 nanometre (nm) wavelength, 120 femtosecond (fs) laser beam pulse. The laser is used to pump the sample device. The laser pulse may be incident on the capping layer of the heterostructure along a first axis (the z-axis), as indicated in FIG. 1a. In alternative embodiments, not shown here, the laser pulse may be incident on the substrate along the −z-axis. In other words, the laser pulse may be incident upon the substrate rather than upon the capping layer. In either case, the laser pulse may be incident upon the device at an angle to the z or −z axis.

An external magnetic field, generated by a magnetic field generator, is optionally applied along a second axis (the −x-axis), perpendicular to the z-axis or −z-axis. The magnetic field intensity may range from a few Oersted (Oe) to tens of Oe. Alternatively, the magnetic field may have an intensity of approximately up to 1000 Oe. The angle (θ) shown in FIG. 1a indicates the rotation for either the external magnetic field, or the laser beam polarization direction.

The capping layer described with reference to FIG. 1a above may be used to protect the heterostructure (i.e. the NM/FM layers) against oxidation and other degradation. The capping layers described herein may comprise an oxide or a nitride layer.

A THz signal is emitted from the emitter device, via a mechanism that will be further described below. The electric field strength of the emitted THz signal is probed by a stroboscopic scheme, as described below.

FIG. 1b illustrates a calculated example of the spin density induced by the femtosecond laser pulse with respect to time in the emitter device NM/FM heterostructure. This provides an overview of spin dynamics in the device. A large number of spin polarized electrons are excited by the laser pulse at the NM/FM interface, decay dramatically in the first 0.15 picoseconds (ps) and then decrease at a much slower rate (t>0.2 ps), generating spin currents along the z-direction, until the system reaches an equilibrium state. The excited diffusive spin currents give rise to fast charge dynamics on a picosecond timescale through the inverse spin Hall Effect (ISHE) and/or through inverse spin orbital torques (ISOT), i.e. wherein spin-polarization causes spin currents, which induce an electrical current. The in-plane electrical charge currents that are generated emit an electromagnetic (EM) wave in the THz frequency range.

FIG. 1c illustrates a typical experimental THz TDS signal emitted along the y-axis (measured in arbitrary units (a.u.), with respect to time (ps). The THz signal in this example is induced by transient charge currents caused by ISHE and in this illustrated example is emitted from a device wherein the heterostructure comprises a high resistance silicon (HR-Si) substrate, a platinum (Pt) 4 nm thick non-magnetic (NM) layer, a Co 4 nm thick ferromagnetic (FM) layer and a silicon dioxide (SiO2) 4 nm thick capping layer. The signal illustrated in FIG. 1c is generated using a laser of wavelength 800 nm, pulse duration 120 fs, repetition rate 1 kHz and averaged power 400 mW.

FIG. 1d illustrates a further typical experimental THz TDS signal emitted along the y-axis (measured in arbitrary units (a.u.), with respect to time (ps). The THz signal in this example is induced by transient charge currents caused by ISHE and/or through inverse spin orbital torques, and in this illustrated example is emitted from a device wherein the heterostructure comprises a quartz substrate, a tungsten (W) 6 nm thick non-magnetic (NM) layer, a Co 3 nm thick ferromagnetic (FM) layer and an aluminium oxide (Al2O3) 4 nm thick capping layer. The device emitting the signal illustrated in FIG. 1d was powered by a compact fibre laser, of wavelength 780 nm, pulse duration 90 fs, repetition rate 100 MHz and averaged power 20 mW, as will be further described below.

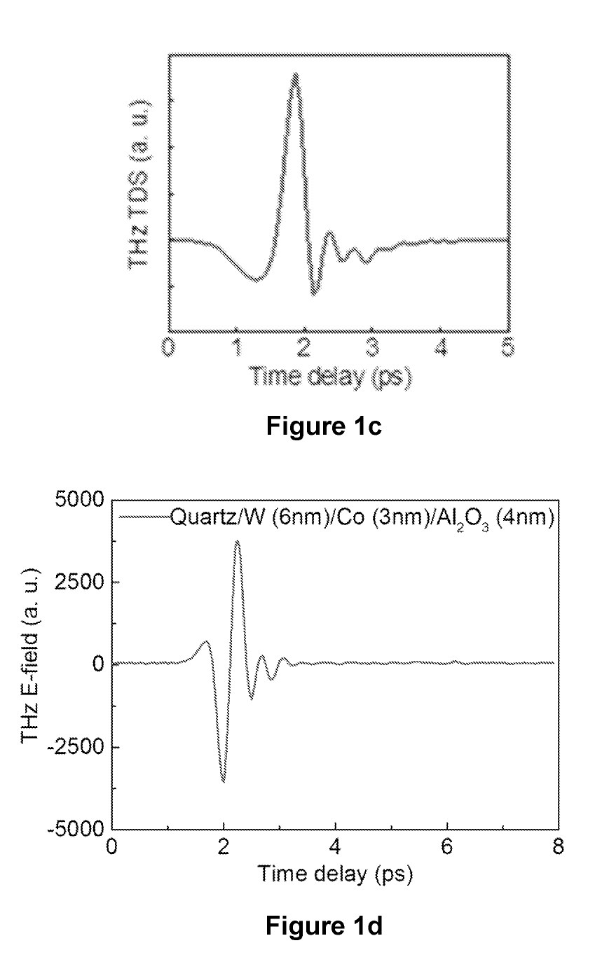

Devices having heterostructures with different non-magnetic layers (NMs) and with a ferromagnetic (FM) layer of Co were studied. The heterostructure in each case was substrate/NM layer (4 nm)/Co layer (4 nm)/SiO2 capping layer (4 nm). The THz TDS signals emitted by these devices over time (ps) are shown in FIGS. 2a to 2g respectively.

In FIG. 2a the NM layer is Pt. In FIG. 2b, the NM layer is iridium (Ir). In FIG. 2c, the NM layer is gadolinium (Gd) and in FIG. 2d the NM layer is ruthenium (Ru). In FIG. 2e, the NM layer is tantalum (Ta), in FIG. 2f the NM layer is tungsten (W) and in FIG. 2g the NM layer is copper (Cu). Reference samples, having either a single Pt (4 nm) or a single Co (4 nm) layer instead of separate FM/NM layers, are shown in FIG. 2h.

Emissions over time from a device heterostructure comprising a 4 nm FM layer of Pt, a 1 nm NM layer of Co40Fe40B20 and a 4 nm SiO2 capping layer are shown in FIG. 2i. The heterostructure of FIG. 2i has perpendicular magnetic anisotropy (PMA).

It will be appreciated from FIGS. 2a to 2d that the THz signals from the devices with a NM layer of Pt, Ir, Gd, and Ru, respectively, show a peak at approximately 2 ps. On the other hand, the signals of FIGS. 2e and 2f illustrate a dip (i.e. the opposite of a peak) at approximately 2 ps, when the NM is Ta or W. No clear peak is observable using the Cu NM layer, as shown in FIG. 2g. It can be appreciated from FIGS. 2a to 2f that the optimal THz signal strengths were obtained where the NM layer comprised Pt (FIG. 2a), and W (FIG. 2f).

The opposite polarities in the THz signals in FIGS. 2a to 2d and FIGS. 2e to 2f indicate that the in-plane charge currents have a 180 degree phase shift in their oscillations. As previously discussed, the spin currents in the bulk of the NM layer and at the NM/FM interface are converted to charge currents via the inverse spin orbit interaction (SOI), such as ISHE and inverse spin orbital torques (ISOT).

The above graphical results indicate that the Ey component of the THz emission (i.e. the resulting electric field of the THz signal along the y-axis) is dominated by the charge current induced by ISHE and/or ISOT. Therefore, the sign change in the THz TDS signal can be attributed to the sign of the spin Hall angle (θSH) of different NMs. These observations are in good agreement with existing reports (H. L. Wang et al, Physics Review Letters 2014, 112, 197201 and T. Tanaka et al, Physics Review B 2008, 77, 165117) that Pt has a positive spin Hall angle, Ta and W have a negative spin Hall angles, and Cu has negligible spin-orbit coupling strength (as illustrated by FIG. 2g). Moreover, the above results show that Ru, Ir, and Gd also possess positive spin Hall angles.

Furthermore, negligible THz signal is generated from either Pt or Co alone (i.e. from samples having either a single Pt (4 nm) or a single Co (4 nm) layer instead of separate FM/NM layers) as shown in FIG. 2h, which indicates that a bi-layer structure of NM/FM is necessary for effective THz generation. The reason for this is that the ISHE and/or ISOT induced transient charge current relies on the existence of both a spin source of FM (e.g. Co) and a spin sink of NM with strong spin-orbit interaction (SOI) (e.g. Pt or W). FIG. 2i shows that there is no THz emission from a FM of CoFeB with perpendicular magnetization anisotropy (PMA) adjacent to a Pt NM layer. Since the magnetization (\vec{M}) direction of the CoFeB film is out-of-plane and the net flow of spin currents (\vec{J}ₛ) is also in the same z-direction, no charge current (\vec{J}_{c}) is expected to be generated due to ISHE (\vec{J}_{c}_{_{∞θSH}}\vec{J}ₛ×\vec{M}).

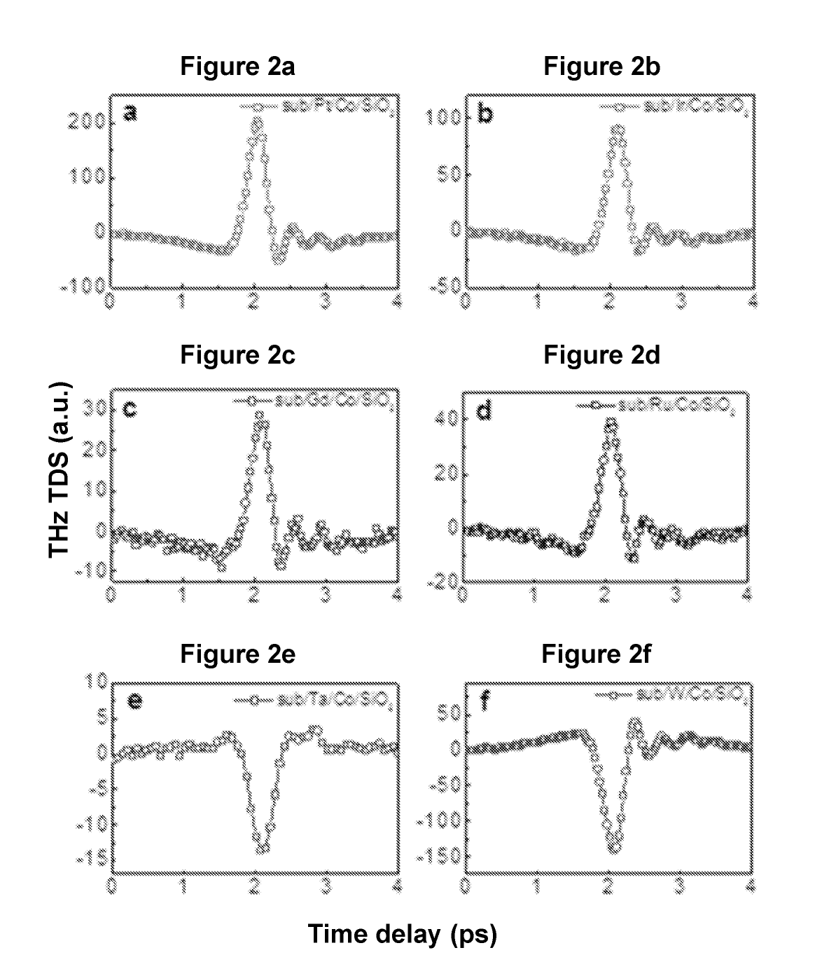

To elucidate the physics behind the THz emission in the above-mentioned devices, a theoretical calculation is performed. A set of corresponding results is shown in FIG. 3a, which illustrates calculated current density (JISHE) in the time domain, where time “0” is defined as the laser incident on the sample. The sample used in FIG. 3a comprised an NM layer material having a positive spin Hall angle (such as Pt). The inset of FIG. 3a illustrates the calculated THz emission from samples with different spin Hall angles (θSH). The samples used in the inset of FIG. 3a comprised NM layer materials having positive and negative spin Hall angles respectively.

Optical excitation in a FM/NM bilayer by a femtosecond laser pulse leads to the demagnetization of the FM layer in the vicinity of the NM layer, which is affected to a large extent through the diffusion of spin currents between the two layers, at different rates for the majority and minority spins. The diffusive spin current in the NM layer with strong SOI gives rise to a bulk charge current through ISHE and/or ISOT, as described above. Using this theoretical model, the ISHE current density has been calculated (see FIG. 3a), and the resulting electric field of the THz signal along the y-axis (Ey), as shown in the inset portion of FIG. 3a. A polarity change in θSH changes the sign of Ey, as shown in the inset portion of FIG. 3a, which agrees with the above experimental results.

To confirm that the Ey signal is dominated by the ISHE and/or ISOT, a thin copper layer was inserted between a NM Pt layer and a FM Co layer in a device heterostructure. The measured THz emission signals (Ey) are shown in FIG. 3b, which illustrates the THz TDS signal from a group of samples, each having a heterostructure comprising glass substrate/Pt 6 nm (NM layer)/Cu n nm/Co 3 nm (FM layer)/Al2O3 capping layer, where n=0, 1, 2, 3, 4, 5, 6, and 8 nm, shown from left to right in FIG. 3b respectively. The data in FIG. 3b is shifted horizontally for clarity.

It will be appreciated from FIG. 3b that as the Cu layer thickness increases (i.e. as n increases), the THz signal intensity decreases gradually. This indicates that the bulk ISHE effect is dominant in the THz TDS signal, since an interface effect would be expected to induce a much sharper decrease as a result of the Cu layer insertion.

A thickness dependence study was carried out on devices having heterostructures comprising a stack of high resistance silicon (HR-Si) substrate/Pt (NM layer)/Co 4 nm (FM layer)/SiO2 cap 4 nm, and HR-Si substrate/W (NM layer)/Co 4 nm (FM layer)/SiO2 4 nm respectively.

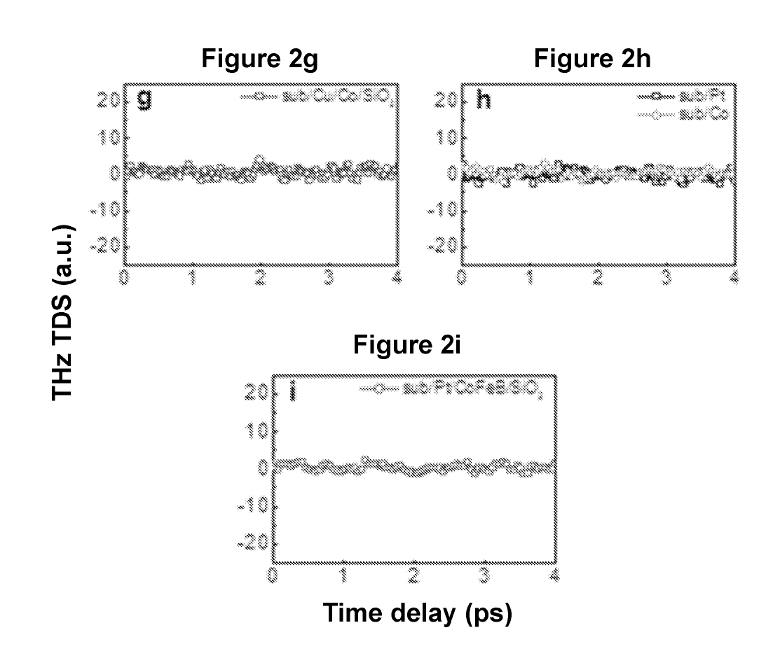

As shown in FIG. 4a, the peak amplitude of THz TDS emissions from both devices increases as the thickness (dNM) of the NM layer (comprising Pt or W respectively) increases, and then saturates. Due to the limited spin diffusion in the NM layer, the charge currents are mostly generated in the vicinity of the FM layer where the non-equilibrium spin currents exist. It can be seen from FIG. 4a that the peak THz signal intensity generally occurs with an NM layer thickness of around 2 to 10 nm, preferably 4 to 8 nm, depending upon the material selected for the NM layer.

The thickness (dFM) of the FM layer (Co) in the devices described with reference to FIG. 4a above was also varied in stacks having Pt and W 4 nm NM layers respectively, as illustrated in FIG. 4b. The THz emissions peak reaches a maximum value with a 1-2 nm Co FM layer and then decreases gradually. This phenomenon is correlated to the laser-induced spin diffusion and THz optical absorption in the Co layer.

Corresponding theoretical calculation results are illustrated in FIGS. 4c and 4d. FIG. 4c illustrates calculated spin accumulations with a 2, 4 and 8 nm NM layer on top of a 4 nm FM layer. The results illustrated in FIG. 4c show that the calculated temporal peak of the spin accumulation increases by increasing the thickness of the NM layer (dNM), indicating consequent higher THz signals, which is similar to the experimental result in FIG. 4a.

FIG. 4d illustrates calculated spin accumulations with a 2, 4 and 8 nm FM layer and a 4 nm NM layer. The results illustrated in FIG. 4d show that the temporal peak of the spin accumulation first increases by increasing the thickness of the FM layer (dFM) and then decreases, as is also evident in the experimental data illustrated in FIG. 4b. An optimal FM layer thickness is therefore around 1 to 8 nm, and preferably 1 to 3 nm, and an optimal NM layer thickness is therefore around 4 to 8 nm, these thicknesses being material dependent.

The amount of spin accumulation is directly related to the strength of the THz emission. Spin accumulation in NM is:

$${\int }_{{d}_{NM}} {\sum }_{E} ( Δ {n}_{tot} ( E , ↑ ) - Δ {n}_{tot} ( E , ↓ ) )$$

where _{Δn}_{ₜₒₜ}(E,↑) and _{Δn}_{ₜₒₜ}(E,↓) are the total changes in spin-up and spin-down densities, respectively, and d_{NM} is the NM thickness.

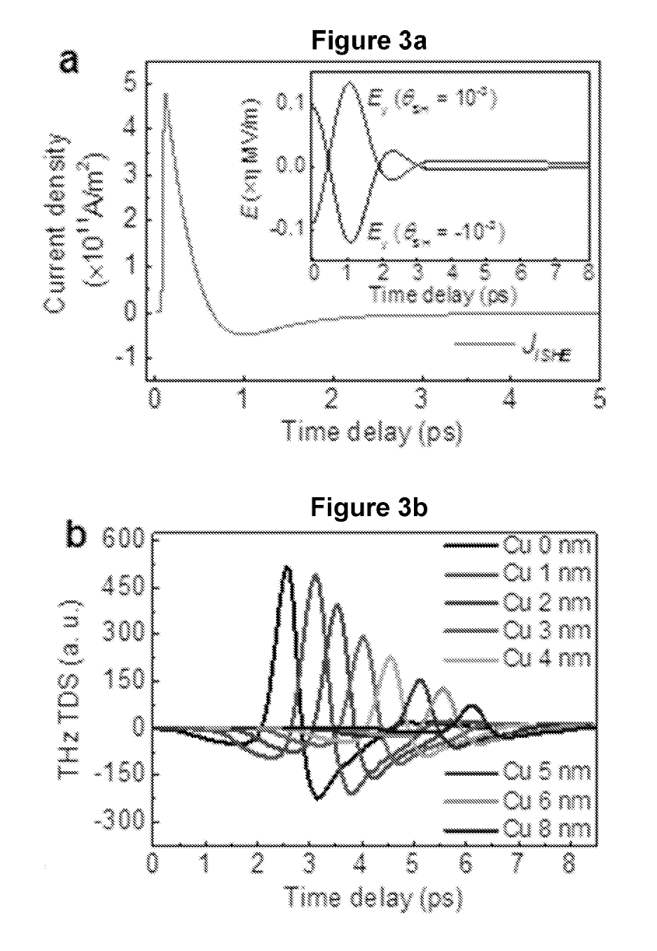

With regard to the material used for the capping layer, which in this example is provided adjacent the FM layer, it can be seen from FIGS. 5a and 5b that sample devices provided with an Al2O3 capping layer have a better THz emission performance than those capped with a SiO2 layer. FIG. 5a illustrates typical THz TDS signals acquired from a standard, 500 μm thick, <110> cut ZnTe crystal with no capping layer (indicated by line A) and a sample having a heterostructure of glass substrate/W (6 nm) NM layer/Co (3 nm) FM layer/Al2O3 (3 nm) capping layer film stack (indicated by line B), under the same experimental configuration. Corresponding frequency domain spectra for the THz TDS signals illustrated in FIG. 5a are shown in FIG. 5b (similarly indicated by lines A and B respectively). The system noise level is indicated by curve C of FIG. 5b, and it can be appreciated that a good signal to noise ratio above 65 dB is achieved from both samples. The thickness of the capping layer in the examples described herein may vary from a few nanometres to hundreds of micrometres.

With reference to FIGS. 5a and 5b, it can be seen that the thin films of the present invention have similar or improved performances in THz radiation generation compared to the ZnTe crystal. Remarkably, the THz emitter device comprising a 12 nm-thick film stack has a higher THz signal peak amplitude in the frequency domain than the ZnTe crystal, as illustrated in FIG. 5b, the peak being at around 0.5 THz in the frequency domain. The measured signal bandwidth is up to 8 THz, which is limited by the 120 fs pulse duration of the laser source (the lower the pulse duration, the higher the bandwidth becomes). However, owing to the thin layers of the emitter devices described herein, and the ultrafast nature of ISHE/ISOT, one can predict that the emitter devices may produce a broader spectrum. A high signal to noise ratio of up to 65 dB is achieved from the THz emitters of the present invention, having heterostructures optimized in accordance with the thickness study described above.

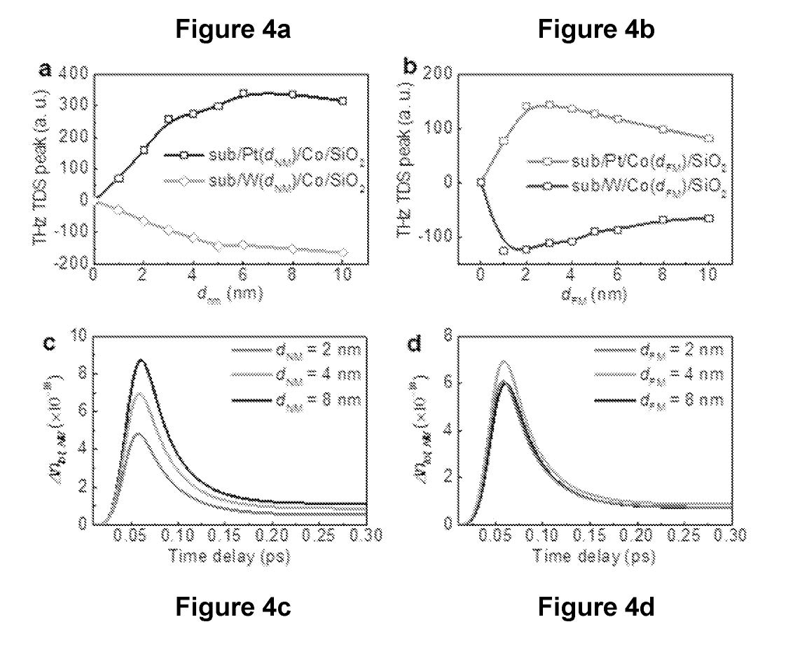

In further accordance with the thickness dependence study described above, a sample device structure was optimized to have a heterostructure of substrate/NM (6 nm) layer/FM (3 nm) layer/capping layer. It was found that film stacks (i.e. thin layers) on glass, sapphire and polyethylene terephthalate (PET) substrates emitted much more intense THz waves than samples on HR-Si wafers. This is illustrated by FIGS. 6a and 6b, as described below. It is believed that the HR-Si substrate wafers may reflect the laser beam back into the FM/NM layers, generating a further THz signal with inverse sign, thereby reducing the overall THz emission intensity. In the devices described herein, substrate thickness may be from 0.0001 mm-10 mm, preferably from 5 μm to 1 mm.

FIG. 6a illustrates THz TDS signals from a first sample device having a heterostructure of Si substrate/Pt (6 nm) NM layer/Co (3 nm) FM layer/Al2O3 (3 nm) cap, as indicated by line A, and a second sample device having a heterostructure of Si substrate/W (6 nm) NM layer/Co (3 nm) FM layer/Al2O3 (3 nm) capping layer, as indicated by line B.

FIG. 6b illustrates THz TDS signals from a sample having a heterostructure of quartz substrate/Pt (6 nm) NM layer/Co (3 nm) FM layer/Al2O3 (3 nm) capping layer, as indicated by line C, and a second sample having a heterostructure of quartz substrate/W (6 nm) NM layer/Co (3 nm) FM layer/Al2O3 (3 nm) capping layer, as indicated by line D.

The results of a study into the dependence of the THz TDS signal emitted by a Pt NM sample on the polarization of the incident laser source beam are illustrated in FIG. 5c. The peak amplitude of THz TDS signals with different laser source beam polarizations for a heterostructure of substrate/Pt (4 nm) NM layer/Co (4 nm) FM layer/SiO2 cap is indicated by line A. The dependence of the peak amplitude of THz TDS signals on the direction of magnetization is also shown in FIG. 5c.

As illustrated in FIG. 5c, to determine the dependence of the detected THz E-field on the magnetic field direction, a magnetic field of 1000 Oe was rotated in the xy-plane for heterostructure samples having Pt and W NM layers (indicated by lines B and C respectively). The rotation angle (θ) of the magnetic field is indicated in FIG. 1a. The peaks of the THz signals follow a sinusoidal trend for both Pt and W samples. As the THz emission is dominated by the components perpendicular to the external magnetic field, the projected E-field strength along the y-axis should be the strongest when the magnetic field (M) is aligned with the ±x-axis (θ=90 and 270°), and the approaching to 0 when M is along the ±y-axis (θ=0 and 180°). The E-field of the THz emissions therefore has a strong magnetization direction dependence.

It can be seen from FIG. 5c that, unlike the strong linear polarization dependence exhibited by a standard THz emitter of <110> ZnTe crystal, there is no angular dependence of THz emission in the Pt/Co structure on laser source beam polarization.

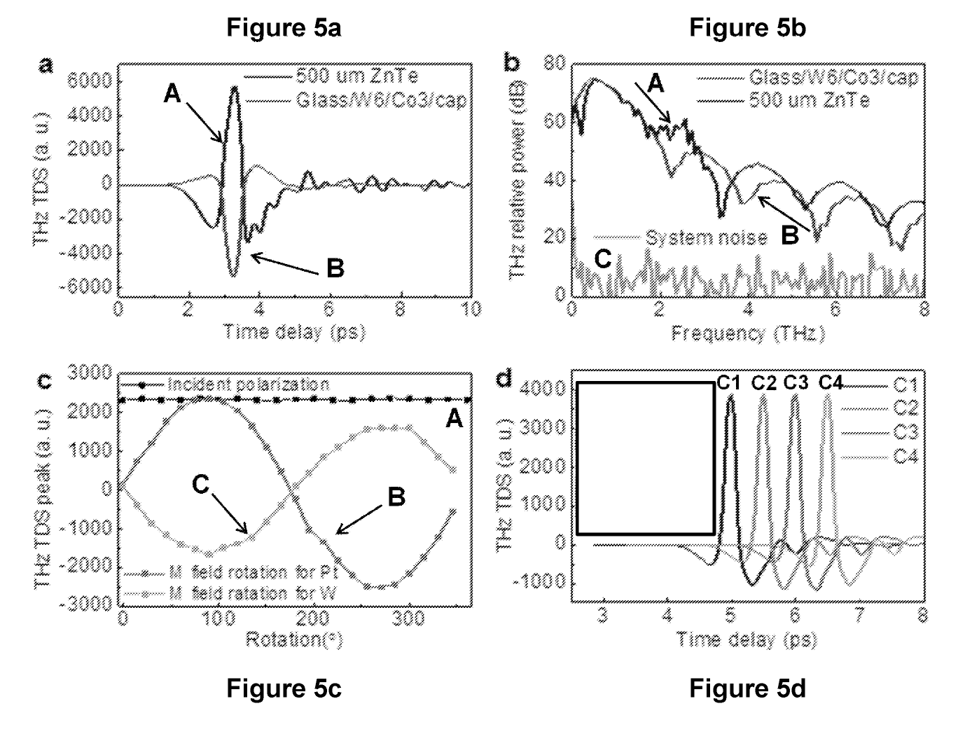

Similarly, rotating the helicity of incident light (circular polarization) causes negligible changes in the THz emission. Incident laser polarization dependence of the THz TDS signal from a heterostructure of substrate/Pt (4 nm) NM layer/Co (4 nm) FM layer/SiO2 (4 nm) substrate is illustrated in FIG. 7. The straight (linear) arrows, elliptical arrows, clockwise arrow, and counter clockwise arrow are used to label the THz signals excited by a linear, elliptical, right hand circularly, and left hand circularly polarized laser source beam respectively. All of the THz pulses are horizontally shifted in FIG. 7 for clarity, therefore they have identical delay positions at the peak values.

The independence of the THz signals on the linear and circular polarization of incident light indicates that the THz generation in the NM/FM stacks does not depend on the non-linear optical response caused by the crystalline structure of the samples, but is mainly attributed to the non-equilibrium spin and charge transport. This behavior is beneficial for stable THz emissions.

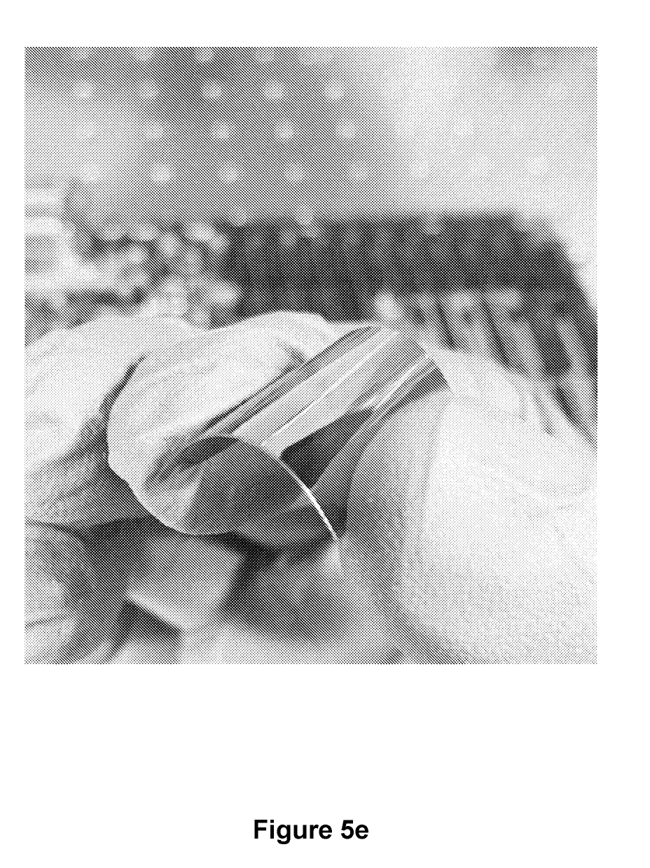

The emitter devices described herein also exhibit high flexibility. With reference to FIG. 5d, a heterostructure comprising a Pt/Co stack (i.e. having a Pt NM layer and a Co FM layer) on a flexible PET film substrate was bent to test the flexibility of the THz emitter. THz TDS signal was acquired from a sample at four different bending curvatures (c, where κ=1/R and R=radius), as follows: C1 (κ=0 m−1), C2 (κ=67 m−1), C3 (κ=125 m−1) and C4 (κ=185 m−1), as illustrated in FIG. 8, which also illustrates the laser incidence direction. It can be seen from FIG. 5d that the device performance did not deteriorate even at large bending curvatures (C4). The data in FIG. 5d is shifted horizontally for clarity. An image of the bent device is shown in FIG. 5e.

It will be appreciated that a flexible THz emitter device may have many applications. For example, for skin cancer scanning, the THz emitter can be bent to fit with human body curvature, which will contribute to a better diagnosis result. For car paint analysis, the THz emitter can be bent to fit with the curvature of the car body, enhancing the application of the THz mapping. For cornea analysis, eye balls are naturally a sphere, where a flexible device is required to be bent to the curvature.

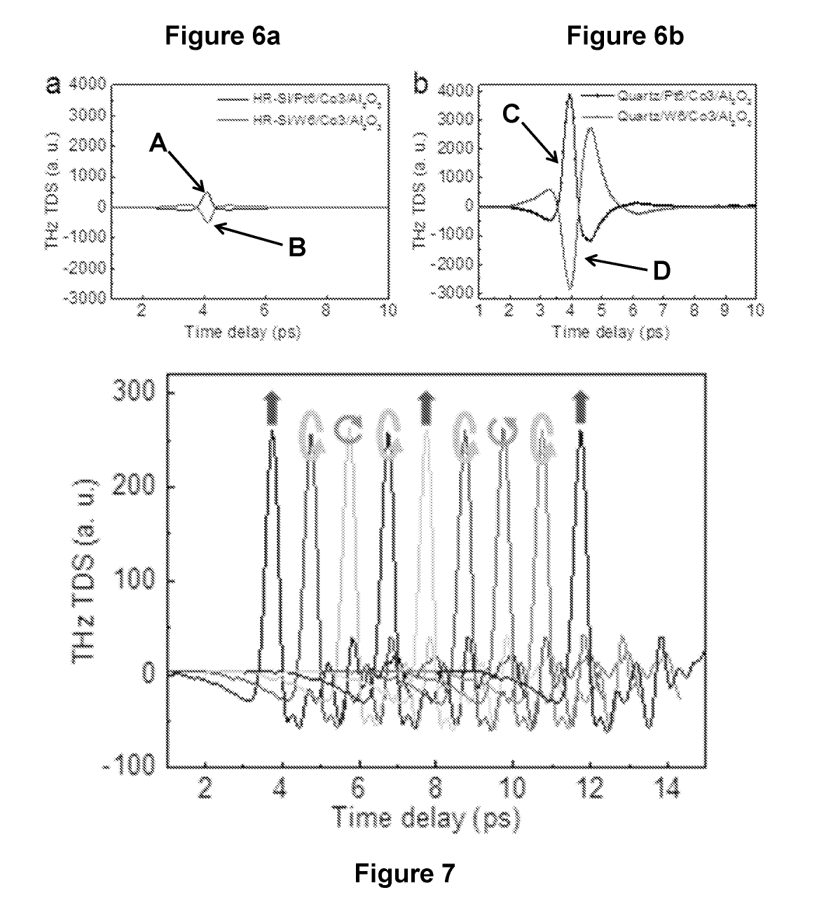

With reference to FIGS. 9a and 9b, the incident laser power dependence of the THz emissions was studied for an emitter device having a heterostructure of quartz substrate/W (6 nm) NM layer/Co (3 nm) FM layer/Al2O3 (3 nm) capping layer. The peak intensity of the THz TDS signal increases initially as the laser beam power density increases, and then shows a saturation trend. Significantly, a clear THz TDS signal is obtained with laser energy density of as low as 0.6 μJ/cm2, which indicates that the THz emitter described herein can be powered by low power laser sources. FIG. 9a illustrates three different ranges for the same emitter device, the ranges representing different laser power ranges in mW. The inset portion of FIG. 9a is a zoomed view of Range 3, which illustrates THz TDS peak emissions at a laser power range of between around 0.2 and 1.0 mW. FIG. 9b illustrates a THz TDS signal acquired with incident laser power of 0.15 mW, equivalent to an energy density of 0.6 μJ/cm2.

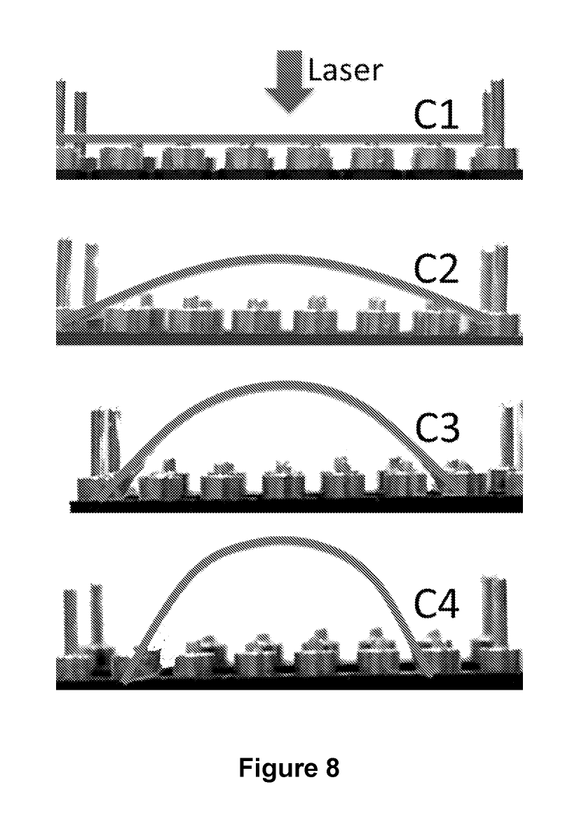

With reference to FIG. 10, laser pulse duration dependence for a device having a heterostructure of Si substrate/Pt (4 nm) NM layer/Co (4 nm) FM layer/SiO2 (4 nm) capping layer is illustrated. It can be appreciated from FIG. 10 that when broadening the laser pulse duration from 50 fs to 80 fs and then to 120 fs, the THz TDS signal shows a slight decrease, distinguished from conventional THz emitters (such as air plasmas), which show an exponential decrease.

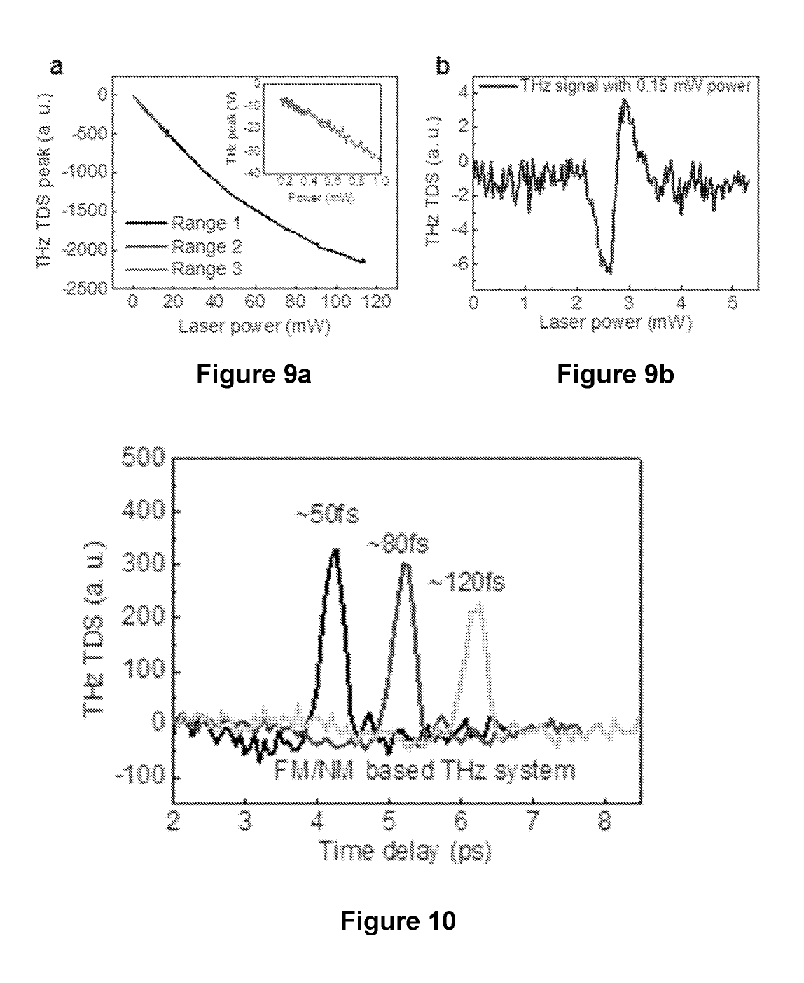

With reference to FIG. 11, the THz TDS signal from an emitter device having a heterostructure of Si substrate/Pt (4 nm) NM layer/Co (4 nm) FM layer/SiO2 (4 nm) capping layer was annealed (for example, heated up from room temperature to a specified temperature, kept at the specified temperature for around 30 minutes and then allowed to cool back down to room temperature slowly over an hour). The emitter device was annealed at different temperatures, ranging from 100° C. to 400° C., for 30 minutes, to further increase the THz emission efficiency. This may be because the annealing process affects the grain size in the emitter films (layers), which can improve the film quality by creating a denser film. However, when the annealing temperature is too high, the inter-diffusive effect amongst layers reduces the device performance. From FIG. 11 it can be seen that the THz signal increases with a proper annealing condition i.e. at annealing temperatures of up to 450° C., preferably 150° C.

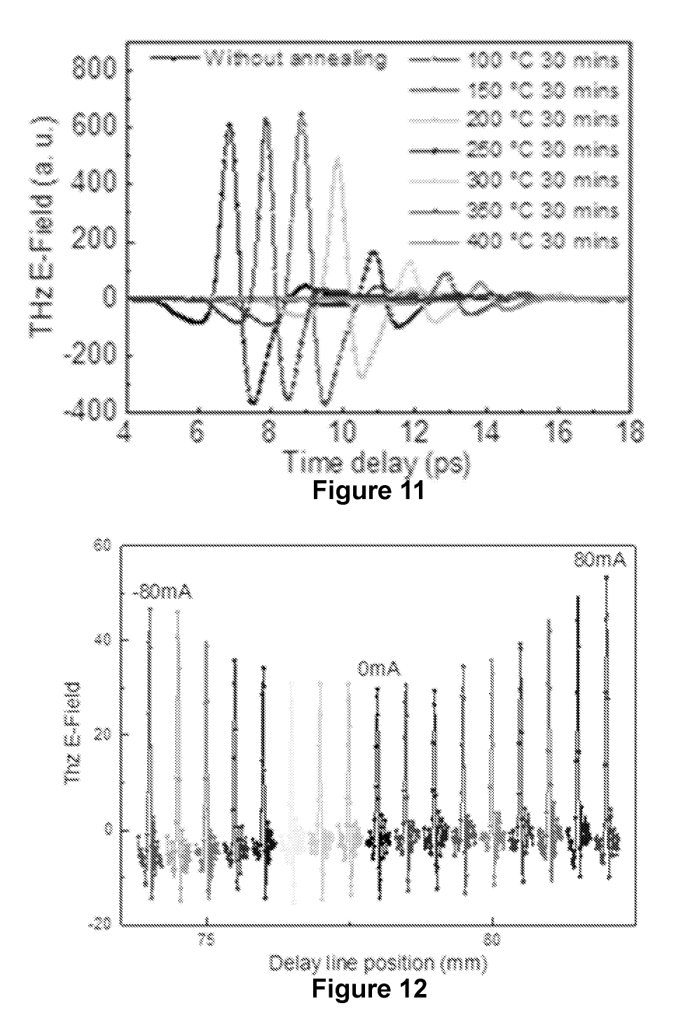

FIG. 12 illustrates THz E-Field intensity with respect to delay line position, which is equivalent to time delay, wherein time delay=(20/3)×delay line position. From FIG. 12, it can be seen that a clear THz TDS signal enhancement is observed in a device having a heterostructure of Si substrate/Pt (4 nm) NM layer/Co (4 nm) FM layer/SiO2 (4 nm) capping layer, by applying DC current or pulsed current with a current density from 102 A/cm2 to 1010 A/cm2, such as an electric current of between −500 milliAmperes (mA) to 500 mA, preferably −80 mA to +80 mA, to the device. It is believed that this may occur as a result of enhancement of the ISHE/ISOT by the electrical current.

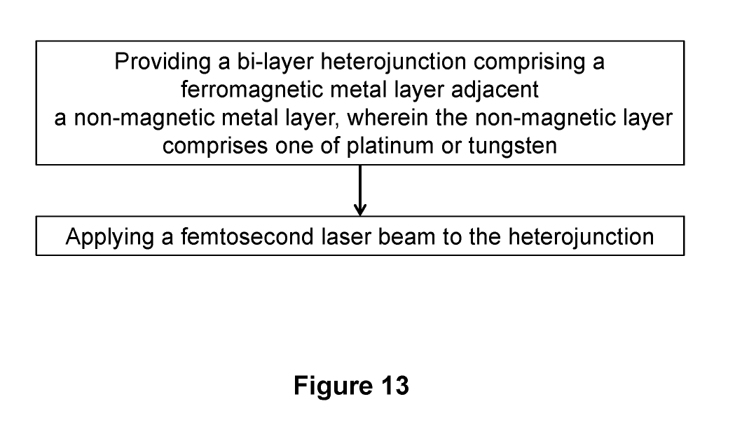

With reference to FIG. 13, a method of generating THz emissions is described. The method comprises providing a bi-layer heterojunction comprising a ferromagnetic metal layer adjacent a non-magnetic metal layer, wherein the non-magnetic metal layer comprises Pt or W. A femtosecond laser beam is applied to the heterostructure, preferably along a longitudinal axis that passes through the ferromagnetic metal layer and the non-magnetic metal layer. Optionally, a magnetic field may be applied along an axis perpendicular to the longitudinal axis. Spin currents are induced in the heterojunction. The spin currents are converted to charge currents by an inverse spin orbit interaction (i.e. ISHE/ISOT), thereby causing emission of electromagnetic radiation in the terahertz frequency range.

A method of preparing a THz emitter device will now be described. The HR-Si and quartz substrates are first cleaned by acetone and isopropyl alcohol and the PET substrates are cleaned by isopropyl alcohol in an ultrasonic bath. The NM, FM and capping layers are then deposited on HR-Si wafers (R>10,000 Ω/cm2), quartz, or PET substrates by a sputtering technique, in which material from a source is deposited as a thin film on a substrate by physical vapour deposition (PVD). The base pressure of the sputter chamber is 3×10-9 Torr. An optimum Ar gas pressure is applied for the deposition and the sample holder is continuously rotated during the deposition.

The order of layer deposition may comprise depositing the NM layer on the substrate, followed by the FM layer and then the capping layer; alternatively, the order may comprise depositing the FM layer on the substrate, followed by the NM layer and then the capping layer. Where one or more underlayers are also included in the device structure, these underlayers may also be deposited in the same way and as part of the same process. While sputtering has been described as the method of deposition in this example, other methods of deposition may also be employed. Additionally, patterning the layers can enhance the absorption coefficient for the laser beam, consequently improving the laser to THz wave conversion efficiency. Patterning the layers can define the layer magnetization, hence an external magnetic field is not required since a fixed magnetic direction is already maintained.

For the experiments described above, an apparatus comprising a laser with the full width at the half maximum of 120 fs, centre wavelength of substantially 800 nm, and 1 kHz repetition rate was used. The laser beam was split into two for the stroboscopic sampling; the THz generation was excited by 220 μJ power with a beam diameter of 8 mm, while a much weak power (˜2 μJ) with a beam diameter of 2 mm was used for THz TDS signal detection (both THz emission and detection beams were not focused).

Generally, for the exemplar devices described herein, the laser pulse width can be 1 femtosecond to 1 picosecond, preferably 10-1000 fs, and the THz signal can be excited by any laser wavelength from around 200 nanometres to around 2 micrometres, preferably 300 nm to 2000 nm. The repetition rate can be from 1 MHz to 3000 MHz and the laser power can be from 2 mW to 10000 mW. The laser power density may be as low as 0.1 nJ/cm2 where a fibre laser is used.

In the experiments described herein, the emitted THz radiation was collected by a parabolic mirror and then focused onto a 500 μm thick ZnTe crystal. Due to the Pockels effect, birefringence is generated when the THz wave shines on the crystal, and subsequently the transmitted detection beam experiences a polarization rotation which can be analyzed by a balanced photodetector system. A pair of magnets was mounted on a rotation stage with magnetic fields (1000 Oe) along the x-axis in a dipole configuration. A wire grid THz polarizer was placed after the sample devices with wires parallel to the magnetic field direction to define the polarization for the THz wave. The THz generation and detection parts were enclosed in a dry environment with a humidity level of 1.5%.

The THz emitter devices described herein exhibit surprisingly excellent performance, based on optimised non-magnetic (e.g. Pt and W) and ferromagnetic metal bi-layer heterojunctions. The THz emission is induced by SOI, e.g. the inverse spin Hall Effect (ISHE), which is demonstrated by the experimental results and supported by the theoretical calculations described above, wherein the NM layer acts as a spin sink and the FM layer acts as a spin source.

A systematic study on film thicknesses demonstrates that the FM/NM bilayer plays the role of spin source/sink. The broadband THz waves emitted from the film stacks described herein have a peak intensity exceeding that from the 500 μm thick ZnTe crystals (comprised in standard THz emitters) with a high signal to noise ratio (SNR), i.e. above 65 dB.

Furthermore, unlike conventional ZnTe emitters, the THz generation from the devices described herein is insensitive to incidence laser beam polarization which indicates the noise resistive feature. In contrast, the THz wave polarization may be fully controllable by an external magnetic field.

As described above, the devices have also been tested on flexible PET substrates, demonstrating that, unlike ZnTe emitters, the devices maintain performance with different bending curvatures. In addition, a clear TDS signal is acquired when the laser energy density is attenuated down to 0.6 μJ/cm2, and this indicates that the devices can be effectively driven by low power lasers as shown in FIG. 1d. A compact fibre laser (100 MHz repetition rate, 785 nm wavelength, and 90 fs pulse width) may be used to replace the regenerative amplified laser. In the modified system, the excitation/detection power is ˜15 mW/5 mW, respectively. FIG. 1d shows that with a very compact, low cost fs fibre laser, a THz signal with a decent signal to noise ratio has been acquired from a Quartz/W (6 nm)/Co (3 nm)/Al2O3 (4 nm) sample. Although the pulse power from the fibre laser is much lower than that of the regenerative amplified 1 kHz laser, the high repetition rate of the fibre laser improves the signal quality greatly.

Together with the low cost and mass productive sputtering growth method for the bi-layer heterojunction thin (i.e. less than 16 nm thick) films or layers, the optimised devices described herein provide intense, broadband, noise resistive, magnetic field controlled, flexible and low power driven THz emitters which can be applied in a wide range of THz equipment and in a wide range of THz TDS systems, in different disciplines such as explosives detection, safety surveillance, chemical composition analysis (medical, food, drugs-of-abuse), material conductivity characterization, integrated circuits failure analysis, and cancer diagnosis. For example, a method of detecting explosive substances and/or drugs-of-abuse comprises the generation of electromagnetic radiation in the THz frequency range, using the method described above, and detecting the presence or absence of absorption peaks at predetermined frequencies. Many explosive materials and drugs-of-abuse (such as cocaine) have their intrinsic absorption peaks within the THz range, and this provides a “fingerprint” of the materials. If such absorption peaks are observed from an item under test, this item can be considered to be likely to contain explosives, and/or drugs-of-abuse.

The THz emitter devices described herein can also be used to characterize spin orbit coupling strength in NM/FM structures. The devices exhibit advantages over traditional electro-optical (EO) crystals in all aspects mentioned above. They can be effectively driven by low power lasers, especially fs lasers.

It will be appreciated by the person skilled in the art that various modifications may be made to the above described embodiment, without departing from the scope of the present invention. For example, as described above, the NM, rather than the FM, layer may be provided adjacent (i.e. in contact with) the substrate. Further, the laser beam may be incident upon the substrate rather than upon the capping layer.

1. A method of generating electromagnetic radiation in the terahertz frequency range, the method comprising the steps of:
providing a bi-layer heterojunction comprising a ferromagnetic metal layer adjacent a non-magnetic metal layer, wherein the non-magnetic layer comprises one of platinum or tungsten; and
applying a femtosecond laser beam to the heterojunction.

2. A method as claimed in claim 1, comprising providing the ferromagnetic metal layer with a thickness of substantially between 1 nanometres and 8 nanometres.

3. A method as claimed in claim 1, comprising providing the non-magnetic metal layer with a thickness of substantially between 2 nanometres and 10 nanometres, or a thickness of substantially between 5 nanometres and 7 nanometres.

4. (canceled)

5. A method as claimed in claim 1, comprising providing the metal layers on a substrate layer, such that the non-magnetic metal layer is adjacent the substrate layer; wherein the substrate layer comprises one of glass, quartz, sapphire, polyethylene terephthalate and silicon.

6. (canceled)

7. A method as claimed in claim 5, comprising providing the substrate layer with a thickness of between substantially 0.0001 mm to 10 mm.

8. A method as claimed in claim 1, comprising providing a capping layer on the metal layers; wherein the ferromagnetic metal layer is arranged adjacent the capping layer.

9. (canceled)

10. A method as claimed in claim 8, wherein the capping layer comprises one of Al₂O₃ or SiO₂.

11. A method as claimed in claim 1, comprising providing a magnetic underlayer adjacent the ferromagnetic metal layer or the non-magnetic metal layer.

12. A method as claimed in claim 8, comprising applying the femtosecond laser beam such that the laser beam is incident upon the capping layer.

13. A method as claimed in claim 1, comprising applying the laser beam in a pulse of substantially between 1 femtosecond to 1 picosecond and at a wavelength of substantially 200 nanometres to 2 micrometres.

14. (canceled)

15. (canceled)

16. A method as claimed in claim 1, comprising applying an external magnetic field to the heterojunction along an axis perpendicular to a direction of application of the laser beam.

17. A method as claimed in claim 16, comprising providing the external magnetic field at substantially 1000 oersted.

18. A method as claimed in claim 1, comprising applying an electric current of substantially between −500 milliamperes and 500 milliamperes to the heterojunction.

19. A method as claimed in claim 1, wherein the terahertz electromagnetic radiation is generated by an inverse spin orbit interaction comprising an inverse spin Hall effect and/or inverse spin orbital torques.

20. A method as claimed in claim 1, wherein emitted terahertz electromagnetic radiation is independent of the polarisation of the incident laser beam.

21. A method as claimed in claim 1, wherein emitted terahertz electromagnetic radiation intensity is independent of the degree of curvature of the terahertz emitter device.

22. A method as claimed in claim 1, comprising annealing the heterojunction at temperatures of up to 450° C. prior to application of the laser beam.

23. (canceled)

24. A terahertz radiation emitter device, comprising:
a bi-layer heterojunction comprising a ferromagnetic metal layer adjacent a non-magnetic metal layer, wherein the non-magnetic layer comprises one of platinum or tungsten;
a substrate layer; and
a capping layer.

25. An apparatus for generating electromagnetic radiation in the terahertz frequency range, comprising:
the terahertz radiation emitter of claim 24; and
a femtosecond laser configured to apply a laser beam to the heterojunction.

26. A method of detecting the presence of explosive substances and/or drugs-of-abuse, comprising generating electromagnetic radiation in the terahertz frequency range according to the method of claim 1, and testing for the presence or absence of absorption peaks at predetermined frequencies.
